(19) United States
(12) Patent Application Publication
(10) Pub. No.: US 2025/0297602 A1
(43) Pub. Date: Sep. 25, 2025

(54) DEVICE FOR PROVIDING HYDROGEN

(71) Applicant: Hoerbiger Wien GmbH, Wien (AT)

(72) Inventors: Bernhard Spiegl, Wien (AT); Matthias Kornfeld, Wien (AT)

(21) Appl. No.: 18/864,112

(22) PCT Filed: May 8, 2023
(86) PCT No.: PCT/EP2023/062079

§ 371 Date: Nov. 8, 2024

(30) Foreign Application Priority Data
May 10, 2022 (AT) A 50329/2022

(51) Int. Cl. F04B 37/18; C25B 1/04; C25B 9/05; C25B 9/23; C25B 15/08; F04B 39/08

(52) U.S. Cl. CPC F04B 37/18; C25B 1/04; C25B 9/05; C25B 9/23; C25B 15/08; F04B 39/08

(57) ABSTRACT

In order to provide a device for providing hydrogen by means of an electrolysis unit which allows the longest possible service life of the electrolysis unit even in case of fluctuating energy supplies to the electrolysis unit, a reciprocating piston compressor is provided to compress the hydrogen generated by the electrolysis unit, the reciprocating piston compressor having at least one automatic intake valve. A unloader is provided in order to hold the intake valve selectively in an open position, an electrically actuatable actuator is provided to activate the unloader, and a control unit is provided to control the actuator, the control unit being designed to actuate the actuator in such a way that an outlet pressure (p1) of the hydrogen at the outlet of the electrolysis unit, or a differential pressure (Δp) between an anode and a cathode of the electrolysis unit, is adjustable to a predefined target value (p1_target, Δp_target).

The invention relates to a device for providing hydrogen, wherein an electrolysis unit for producing the hydrogen is provided in the device. The invention also relates to a method for operating such a device.

Ongoing climate change has led to increasingly strict political regulations regarding permissible CO2 emissions into the atmosphere. Efforts are being made to find alternatives to well-known fossil fuels (diesel, petrol, natural gas, etc.), especially for transport. One possible way is, for example, the use of battery-powered vehicles having electric drives. Previously generated electrical energy is thereby stored in batteries and used to drive electric motors. However, the extent to which CO2 is reduced is heavily dependent on what generates the electricity and also on the energy used to produce the batteries. However, pure battery electric operation is currently not yet economically viable, particularly for commercial vehicles, mainly due to the poor weight or size to storage capacity ratio. Suitable batteries would therefore be too large and/or too heavy, which would unduly limit the transport capacity.

Another possibility is the use of hydrogen to power vehicles. The hydrogen can, for example, be used as fuel in modified internal combustion engines or can be converted into electrical energy in a fuel cell, which in turn can be used to drive electric motors. Hydrogen can be stored, for example, in liquid form in suitable low-temperature tanks or in gaseous form at sufficiently high pressures in pressure vessels. This already makes it possible to also achieve similarly high ranges in commercial vehicles as with previous drives. Electrolysis is known in the art for the production of hydrogen. Water is broken down into hydrogen (H₂) and oxygen (O₂) using electrical energy. In this case, various types of electrolysis units, so-called electrolyzers, are known, which differ in terms of their design. Hydrogen is provided at a certain pressure at the outlet of an electrolysis unit (regardless of the design). Even in hydrogen production, the CO₂ reduction therefore depends on what generates the electricity used to supply power to the electrolysis unit.

It is therefore particularly advantageous if renewable energy sources, such as wind power or photovoltaics, are used to supply energy to the electrolysis unit. In contrast to conventional energy sources, especially fossil ones, the electricity is generally not always generated constantly, but is strongly dependent on the currently prevailing environmental conditions. With wind turbines, electricity generation varies with wind strength and is therefore naturally not constant. In photovoltaic systems, electricity generation varies with solar radiation, which is usually not constant either, for example due to clouds or shade. If the electrolysis unit is directly connected to the corresponding energy source, the electrical energy supply to the electrolysis unit thus also fluctuates depending on the fluctuations in the electricity generated by the energy source. However, a fluctuating electricity supply to an electrolysis unit is undesirable because it leads to pressure fluctuations of the hydrogen produced at the outlet of the electrolysis unit. These pressure fluctuations in turn have a negative impact on durability and consequently on the service life of the electrolysis unit.

It is therefore an object of the invention to provide a device for providing hydrogen by means of an electrolysis unit, which enables the electrolysis unit to have the longest possible service life even when the energy supply to the electrolysis unit fluctuates.

The object is achieved by the device mentioned at the outset in that a reciprocating piston compressor is provided for compressing the hydrogen produced by the electrolysis unit, that the reciprocating piston compressor has at least one automatic intake valve, that a unloader is provided to selectively hold the intake valve in an open position, that an electrically actuable actuator is provided for actuating the unloader and that a control unit is provided for controlling the actuator, wherein the control unit is designed to actuate the actuator in such a way that an outlet pressure of the hydrogen at the outlet of the electrolysis unit or a differential pressure between an anode and a cathode of the electrolysis unit can be adjusted to a predetermined target value. If the electrolysis unit has a proton exchange membrane between the anode and the cathode, the differential pressure can be a differential pressure at the proton exchange membrane. This means that, for example in the case of a fluctuating energy supply to the electrolysis unit, which previously led to a fluctuating output pressure, a desired target value can be set for the outlet pressure relatively quickly by controlling the unloader.

For example, a fixed numerical value can be provided as the target value or a function for determining the target value on the basis of at least one other variable, preferably time, can also be stored in the control unit. This allows a constant outlet pressure or differential pressure to be set regardless of the potentially fluctuating energy supply. Alternatively, a specific time course of the outlet pressure or the differential pressure can also be set. This can be advantageously provided, for example, when switching off the electrolysis unit or when the power supply is interrupted in order to reduce the outlet pressure to a certain pressure relatively slowly and in a controlled manner.

Preferably, a determination unit is provided for determining an actual value of the outlet pressure or the differential pressure and the control unit is designed to use the determined actual value to control the outlet pressure or the differential pressure to the predetermined target value. The determination unit preferably has at least one sensor and/or a calculation model, wherein the calculation model is preferably stored in the control unit. For example, a pressure sensor for recording an actual value of the outlet pressure of the hydrogen at the outlet of the electrolysis unit can be provided as the sensor. The pressure sensor can be arranged in a connecting line that connects the output of the electrolysis unit to the piston compressor. A differential pressure sensor can also be provided for recording an actual value of the differential pressure.

The control unit is preferably designed to determine a manipulated variable for the actuator from the determined actual value and the predetermined target value and to actuate the actuator using the determined manipulated variable. For this purpose, it is advantageous if the control unit has a suitable controller, for example a PI controller or PID controller, to determine the manipulated variable. This enables a closed control loop to be realized, whereby the outlet pressure or differential pressure can be adjusted with high precision.

Additionally or alternatively, a function for determining a manipulated variable for the actuator on the basis of the predetermined target value can also be stored in the control unit and the control unit can be designed to determine a manipulated variable for the actuator from the function and to actuate the actuator using the determined manipulated variable. This makes it possible to implement (feedforward) open-loop control that is simpler than (feedback) closed-loop control. The function can be considered to be known or can optionally be determined from tests.

Preferably, an electrical energy source is provided for supplying energy to the electrolysis unit and/or the reciprocating piston compressor. This makes it possible, for example, to supply energy to the entire device from a single energy source. Particularly preferably, the energy source comprises a regenerative energy generation apparatus which is connected to the electrolysis unit and/or to the reciprocating piston compressor, wherein the energy generation apparatus preferably comprises a photovoltaic system or a wind turbine. This means that a renewable energy source can be used to produce the hydrogen, which is advantageous for ecological reasons. Since regenerative energy generation apparatuses generally do not generate energy that is constant over time due to environmental conditions, the open-loop control or closed-loop control according to the invention of the outlet pressure or the differential pressure is particularly advantageous because they allow fluctuations, for example, to be compensated for quickly and easily.

The actuator is preferably designed as a pneumatic, hydraulic or electromagnetic actuator. Due to the short reaction time, an electromagnetic actuator is particularly advantageous in order to be able to react as quickly as possible to rapid pressure fluctuations.

It is advantageous if the at least one automatic intake valve is designed as an annular valve, wherein the annular valve preferably has multiple ring-shaped valve openings and a plurality of ring-shaped valve elements which can be actuated by the unloader. This design has already proven successful in previous compressors.

The reciprocating piston compressor can preferably also be designed as a double-acting reciprocating piston compressor and/or as a multi-stage reciprocating piston compressor. By choosing a suitable design for the reciprocating piston compressor, the device can be flexibly adapted to requirements.

The electrolysis unit can, for example, be directly supplied with electrical energy that is not constant over time by a regenerative energy generation apparatus and the control unit can control the outlet pressure or the differential pressure to a predetermined, for example constant, target value.

If the electrolysis unit is deactivated or an electrical energy supply to the electrolysis unit is interrupted, the control unit can, for example, also reduce the outlet pressure to a specified value according to a predetermined time function. This allows the outlet pressure to be reduced slowly, for example, which is beneficial for the fatigue strength of the electrolysis unit.

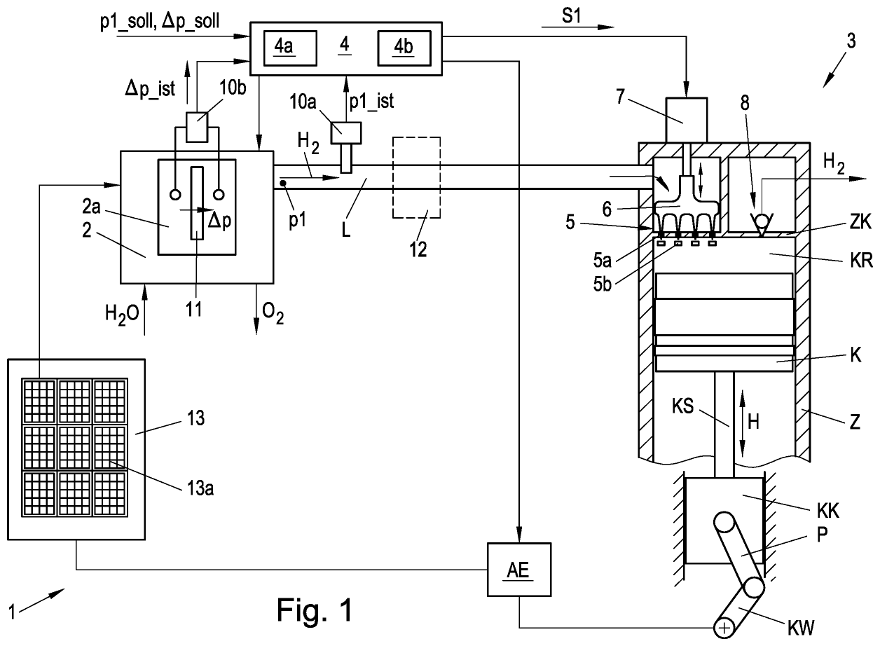

In the following, the present invention is described in greater detail with reference to FIG. 1 which, by way of example, shows a schematic and non-limiting advantageous embodiment of the invention. In the figures:

FIG. 1 shows a device for providing hydrogen in an exemplary embodiment of the invention.

The device 1 shown in FIG. 1 comprises an electrolysis unit 2 for producing hydrogen H₂ and a reciprocating piston compressor 3 for compressing the hydrogen H₂ produced by the electrolysis unit 2. Furthermore, a control unit 4 is provided for controlling the device 1. The control unit 4 has suitable hardware and/or software. Such control units 4 are known in the art, and therefore no further description is given here. In FIG. 1, the control unit 4 is designed, by way of example, to control the electrolysis unit 2 and the piston compressor 3. However, this should only be understood as an example and a separate electrolysis control unit 4a for the electrolysis unit 2 and a separate compressor control unit 4b for the piston compressor 3 could also be provided, as indicated in FIG. 1. In this case, the control units 4a, 4b can communicate with each other in a suitable manner in order to exchange sensor signals and/or control signals (described in more detail below). In principle, however, it would also be sufficient within the scope of the invention if only one compressor control unit 4b for controlling the piston compressor 3 were provided. This substantially depends on the choice of the operating variable to be set for the electrolysis unit 2, which variable will be described in more detail below.

In the example shown, an electrical energy source 13 is provided for supplying energy to the electrolysis unit 2 and the reciprocating piston compressor 3. The energy source 13 here comprises, for example, a regenerative energy generation apparatus 13a, which is connected to the electrolysis unit 2 and to a drive unit AE of the reciprocating piston compressor 3. In an advantageous embodiment, the energy generation apparatus 13a comprises, for example, a photovoltaic system, as indicated in FIG. 1. Alternatively or additionally, the energy generation apparatus 13a could also comprise a wind turbine (not shown) or another suitable regenerative energy generation apparatus 13a.

The structure and function of a reciprocating piston compressor 3 are well known, which is why the reciprocating piston compressor 3 is shown only schematically in FIG. 1. In a known manner, a reciprocating piston compressor 3 has a plurality of cylinders Z, in each of which a piston K can be moved back and forth in an oscillating stroke movement H between a top dead center and a bottom dead center. In FIG. 1, a single cylinder Z is shown by way of example, but of course the reciprocating piston compressor 3 can also comprise a plurality of cylinders Z. In the example shown, the piston K is driven via a piston rod KS, which is connected to a crosshead KK.

The crosshead KK in turn is connected to a (schematically indicated) crank drive. The crank drive has a crankshaft KW and a connecting rod P for each piston K. The crankshaft KW is driven by a suitable drive apparatus AE, for example an electric machine. The drive apparatus AE is supplied with electrical energy by the same energy source 13 as the electrolysis unit 2 in this case. Of course, the drive apparatus AE of the piston compressor 3 could, however, also be supplied with driving energy by a separate energy source. The crosshead KK is connected to the crankshaft KW via the connecting rod P and is driven thereby. The crosshead supports the lateral force generated by the connecting rod P on the housing of the reciprocating compressor 3 such that the piston rod KS performs a substantially purely oscillating movement that is as free from lateral forces as possible. In principle, however, the piston compressor 3 could also be designed without a crosshead KK, in which case the piston K is driven directly via the connecting rod P.

In the cylinder Z, a compression chamber KR is provided, which is limited at one end by the movable piston K and at the other end by a wall of the piston compressor 3, for example by a cylinder head ZK. At least one intake valve 5 and at least one pressure valve 8 are provided in the region of the compression chamber KR for gas exchange. Contrary to the arrangement shown, multiple intake valves 5 and/or multiple pressure valves 8 could of course also be provided. A radial arrangement on the cylinder Z would of course also be possible. During an expansion stroke of the piston K, the compression medium, here the hydrogen H₂ produced by the electrolysis unit 2, is drawn in by the open intake valve 5 and flows into the compression chamber KR. During a subsequent compression stroke of the piston K, the compression medium is compressed. When a specified pressure is reached, the pressure valve 8 opens and the compression medium can flow through the open pressure valve 8. The compressed compression medium can then be fed, for example, to a suitable storage device (not shown) or to a consumer (not shown), e.g., a fuel cell.

The reciprocating piston compressor 3 has at least one automatic intake valve 5, which opens automatically due to the pressure conditions during an expansion stroke of the piston K and closes automatically during a compression stroke of the piston K. Therefore, no external energy is required to actuate the valve, such as an actuator. Furthermore, an unloader 6 is provided, with which the intake valve 5 can be selectively held in an open position regardless of the prevailing pressure conditions. The intake valve 5 is preferably designed as an annular valve, wherein the annular valve preferably has multiple ring-shaped valve openings 5a and multiple ring-shaped valve elements 5b. The valve elements 5b seal the valve openings 5a when the annular valve 5 is closed. In this case, the unloader 6 preferably has multiple unloader fingers which can actuate the valve elements 5b through the valve openings 5a. Ring valves of the type in question are known in the art and therefore a detailed description is not given here.

Furthermore, an electrically actuable actuator 7 is provided for actuating the unloader 6. The actuator 7 can be designed, for example, as a pneumatic, hydraulic or electromagnetic actuator, wherein electromagnetic actuation is preferred due to the short switching times.

The pressure valve 8 is only shown schematically in FIG. 1 and can, for example, also be designed as an automatic valve similarly to the intake valve 5. In this case, with a certain pressure ratio, the valve elements would open into a side facing away from the compression chamber KR. Alternatively, however, another suitable valve could of course also be provided as the pressure valve 8, for example a non-automatic valve that can be actuated by a suitable actuator.

Contrary to the embodiment shown, the reciprocating piston compressor 3 can also be designed, for example, as a double-acting reciprocating piston compressor. In the cylinder Z, a first compression chamber KR is provided on the side of the piston K facing away from the crank drive (as shown in FIG. 1) and, in addition, a second compression chamber KR (not shown) is also provided on the side of the piston K facing the crank drive. Of course, at least one intake valve and one pressure valve are in turn provided for gas exchange in the second compression chamber KR.

The reciprocating piston compressor 3 could of course also be designed as a multi-stage compressor. Here, multiple cylinders Z with compression chambers KR with different compression ratios are provided. In this case, the pressure valve of a first compression chamber would be connected to the intake valve of a subsequent second compression chamber. The compression medium, here hydrogen H₂, would then be compressed in multiple stages to a desired final pressure. Both double-acting reciprocating piston compressors and multi-stage compressors are known in the art. A combination of a double-acting reciprocating compressor and multi-stage compressor would of course also be conceivable. In this case, it is advantageous if at least the first compressor stage at the outlet of the electrolysis unit 2 has an automatic intake valve 5 with an unloader and actuator 7.

The control unit 4 (or the compressor control unit 4b) is designed to actuate the actuator 7 such that an outlet pressure p1 of the hydrogen H₂ at the outlet of the electrolysis unit 2 or a differential pressure Δp between an anode and a cathode of the electrolysis unit 2 can be adjusted to a predetermined target value. If the electrolysis unit 2 comprises a PEM electrolyzer 2a having a proton exchange membrane between the anode and the cathode, the differential pressure Δp is preferably a differential pressure Δp at the proton exchange membrane 11. During operation of the device 1, the reciprocating piston compressor 3 is preferably operated at a fixed constant speed. For this purpose, the control unit 4 (or the compressor control unit 4b) can accordingly actuate the drive unit AE of the reciprocating piston compressor 3.

Preferably, a target value is specified for the operating variable, for example a target pressure p1_target for the hydrogen H₂ at the outlet of the electrolysis unit 2 or a target pressure difference Δp_target for the differential pressure Δp at the membrane 11. The control unit 4 can use the predetermined target value for open-loop or closed-loop control of the actuator 7. This makes it possible, for example, to set a constant outlet pressure p1 for the hydrogen H₂ at the outlet of the electrolysis unit 2 or a constant pressure difference Δp at the membrane 11 by controlling the at least one intake valve 5 by means of the unloader 6. This ensures that the outlet pressure p1 or the pressure difference Δp remains constant even if the energy supplied by the energy source 13, for example the photovoltaic system 13a, fluctuates. Normally, a fluctuating energy supply would lead to pressure fluctuations of the outlet pressure p1, which, however, has a detrimental effect on the durability of the electrolysis unit 2, in particular of a membrane 11, as mentioned at the outset.

The target value can, for example, be a fixed numerical value, for example a target outlet pressure p1_target in the range from 15 bar to 40 bar or a predetermined target differential pressure Δp_target. At full load of the electrolysis unit 2, the target outlet pressure p1_target can, for example, be in the region of 30 bar. At partial load, the target outlet pressure p1_target can be in the region of 25 bar, for example. Furthermore, it may also be advantageous to keep the outlet pressure p1 at a fixed value after the electrolysis unit 2 has been deactivated. This can be advantageous for a rapid restart of the electrolysis unit 2.

The control unit 4 can also contain a function for determining the target value on the basis of at least one further variable, e.g., on the basis of time. As a result, for example when the electrolysis unit 2 is deactivated, the outlet pressure p1 can be reduced in a controlled manner from a first value to a second, lower value, e.g., using a time function in the form of a ramp. This can prevent an abrupt drop in pressure at the outlet of the electrolysis unit 2 after the electrolysis unit 2 is switched off, which could have a detrimental effect on the durability of the electrolysis unit 2.

In order to implement closed-loop (feedback) control, a determination unit for determining an actual value p1_actual of the outlet pressure p1 or an actual value Δp_actual of the differential pressure Δp is preferably provided. In this case, the control unit 4 is preferably designed to use the determined actual value to control the outlet pressure p1 or the differential pressure Δp to the predetermined target value.

The determination unit can comprise at least one sensor and/or a calculation model, wherein the calculation model is preferably stored in the control unit 4. As shown in FIG. 1, for example, a pressure sensor 10a can be provided for recording an actual value p1_actual of the outlet pressure p1 of the electrolysis unit 2. The pressure sensor 10a could, for example, be provided directly at the outlet of the electrolysis unit 2 and/or be part of the electrolysis unit 2. The pressure signal recorded by the pressure sensor 10a could then be transmitted to the control unit 4 and processed thereby in order to control the actuator 7.

If a separate electrolysis control unit 4a and a separate compressor control unit 4b are provided, the sensor signal of the pressure sensor 10a could, for example, also be transmitted to the electrolysis control unit 4a and from there to the compressor control unit 4b. A direct transmission of the sensor signal to the compressor control unit 4b would of course also be possible. This last variant is particularly advantageous when an existing electrolysis unit 2 is retrofitted with a compressor 3 for pressure control, because in this case access to the electrolysis control unit 4a is sometimes not possible.

As shown in FIG. 1, the output of the electrolysis unit 2 can be connected via a connecting line L to the piston compressor 3, in particular to a suction line of the piston compressor 3. The produced hydrogen H₂ can then be fed to the at least one automatic intake valve 5 of the piston compressor 3 via the connecting line L. The pressure sensor 10a can then be arranged, for example, in the connecting line L. If necessary, further apparatuses 12, for example filters, can also be arranged between the outlet of the electrolysis unit 2 and the inlet of the piston compressor 3, as indicated by dashed lines in FIG. 1. In this case, the pressure sensor 10a could be arranged in the flow direction upstream of the filter 12, or even downstream. In general, within the scope of the invention, the outlet pressure p1 is to be understood as the pressure at any point in the connecting line L between the outlet of the electrolysis unit 2 and the inlet of the piston compressor 3.

Alternatively or in addition to the pressure sensor 10a, it may also be advantageous if a differential pressure sensor 10b is provided for recording an actual value Δp_actual of a differential pressure Δp on the membrane 11. This makes it possible not only to control the outlet pressure p1, but also, for example, to control a constant differential pressure Δp at the membrane 11. This is advantageous because the membrane 11 of the electrolyzer 2a is relatively sensitive to excessive pressure differences between the anode side and the cathode side. Either a suitable sensor can be used as differential pressure sensor 10b, or two pressure sensors can also be used, from the difference of which the differential pressure Δp of interest is determined, for example by the control unit 4.

Alternatively or in addition to potential sensors, the determination unit could also have a calculation model for determining an actual value. The calculation model can, for example, be stored in the control unit 4, for example in the form of a mathematical function, a characteristic curve or a characteristic map. The calculation model could be known, for example specified by the manufacturer of the electrolysis unit 2. Alternatively, it could also be determined empirically through tests, for example. Using the calculation model, the actual value p1_actual of the outlet pressure p1 or the actual value Δp_actual of the differential pressure Δp can be calculated from other available variables. For example, it would be conceivable that the outlet pressure p1 of the hydrogen H₂ at the output of the electrolysis unit 2 is determined from a measured electrical variable, e.g., from the current electrical current, the current electrical voltage or the current electrical power of the electrolysis unit 2. The electrical measured quantities can be recorded relatively easily using suitable measuring apparatuses.

The measuring apparatus for recording the measured electrical variable (current, voltage, power) could, for example, be integrated in the electrolysis unit 2, as an integral part of the electrolysis unit 2. In this case, the measured variable could be transmitted to the control unit 4 (e.g., the electrolysis control unit 4a) and used by the control unit 4 as an input variable in the calculation model. The control unit 4 can, for example, determine the actual value p1_actual of the outlet pressure p1 at the output of the electrolysis unit 2 as an output variable.

Alternatively, however, a separate measuring apparatus (not shown), which is not part of the electrolysis unit 2, could also be provided for recording the measured electrical variable (current, voltage, power). The separate measuring apparatus can be arranged, for example, on a supply line via which the electrolysis unit 2 is supplied with electrical energy from the energy source 13. The measured variable recorded by the separate measuring apparatus could in turn be transmitted to the control unit 4 (in this case, for example, the compressor control unit 4b) and used by the control unit 4 as an input variable in the calculation model. The variant with the separate measuring apparatus can also be advantageously used for retrofitting an existing electrolysis unit 2.

The control unit 4 can determine a suitable manipulated variable S1 for the actuator 7 from the determined actual value (for example the actual value p1_actual of the outlet pressure p1 or the actual value Δp_actual of the differential pressure Δp) and the predetermined target value (for example a constant target value p1_target of the outlet pressure p1 or a constant target value Δp_target of the differential pressure Δp) and actuate the actuator 7 using the determined manipulated variable S1. In order to determine the manipulated variable S1, a suitable controller is preferably provided in the control unit 4, for example a PI controller or PID controller. The type of manipulated variable S1 depends on the specific design of the actuator 7 and can be, for example, an electrical current or an electrical voltage. The actuator 7 then adjusts the unloader 6, preferably continuously, depending on the manipulated variable S1, in order to actuate the intake valve 5 so as to adjust the outlet pressure p1 or the differential pressure Δp.

In principle, however, no closed-loop (feedback) control needs to be provided, but open-loop (feedforward) control could also be used. For example, for this purpose in order to determine a manipulated variable S1 for the actuator 7, a function of the manipulated variable S1 can be stored in the control unit 4 as a function of the predetermined target value (e.g., as a function of the target value p1_target of the outlet pressure p1 or the target value Δp_target of the differential pressure Δp). The control unit 4 can then use the function to determine the manipulated variable S1 for the actuator 7 from the target value and actuate the actuator 7 using the determined manipulated variable S1. The function can, for example, in turn be stored in the control unit 4 as a mathematical function, as a characteristic curve or as a characteristic map. The function can either be known or a suitable function can be determined, for example, through experiments.

The electrolysis unit 2 can, for example, be directly supplied with electrical energy that is not constant over time by a regenerative energy generation apparatus 13a, i.e., without any electrical consumers or electrical storage devices arranged therebetween. The control unit 4 can control the outlet pressure p1 or the differential pressure Δp as described to a predetermined, for example constant, target value. If the electrolysis unit 2 is deactivated or an electrical energy supply to the electrolysis unit 2 is interrupted, the control unit 4 can reduce the outlet pressure p1 to a specified value, for example additionally according to a predetermined time function. As a result, the outlet pressure p1 can be reduced in a controlled manner within a predetermined time, for example from a full load pressure of approximately 30 bar, to a specified lower pressure, when the electrolysis unit 2 is switched off. If the electrolysis unit 2 is only switched off temporarily, the outlet pressure p1 could, for example, also be kept at a relatively high value by appropriate control of the actuator 7, which value is in the region of the outlet pressure p1 before the electrolysis unit is switched off.

1. A device for providing hydrogen, comprising: wherein
an electrolysis unit for producing hydrogen;
a reciprocating piston compressor for compressing the hydrogen produced by the electrolysis unit, wherein the reciprocating piston compressor has at least one automatic intake valve;
an unloader, the unloader being configured to selectively hold the intake valve in an open position;
an electrically actuable actuator for actuating the unloader; and
a control unit for controlling the actuator, the control unit being designed to actuate the actuator in such a way that an outlet pressure of the hydrogen at the outlet of the electrolysis unit or a differential pressure between an anode and a cathode of the electrolysis unit can be adjusted to a predetermined target value.

2. The device according to claim 1, wherein the electrolysis unit includes a proton exchange membrane between the anode and the cathode and that the differential pressure is a differential pressure at the proton exchange membrane.

3. The device according to claim 1, wherein the target value is a fixed numerical value or a function for determining the target value on the basis of at least one further variable, preferably time, is stored in the control unit.

4. The device according to claim 1, wherein a determination unit for determining an actual value of the outlet pressure or the differential pressure is provided and the control unit is designed to use the determined actual value to control the outlet pressure or the differential pressure to the predetermined target value.

5. The device according to claim 4, wherein the determination unit has at least one sensor or the determination unit has a calculation model, wherein the calculation model is stored in the control unit.

6. The device according to claim 4, wherein the at least one sensor comprises a pressure sensor for recording an actual value of the outlet pressure of the hydrogen at the outlet of the electrolysis unit, wherein the pressure sensor is arranged in a connecting line which connects the outlet of the electrolysis unit to the piston compressor or the at least one sensor has a differential pressure sensor for recording an actual value of the differential pressure.

7. The device according to claim 4, wherein the control unit is configured to determine a manipulated variable for the actuator from the determined actual value and the predetermined target value and to actuate the actuator using the determined manipulated variable, wherein the control unit has a controller for determining the manipulated variable (S1).

8. The device according to claim 1, wherein a function for determining a manipulated variable on the basis of the predetermined target value is stored in the control unit and the control unit is configured to determine a manipulated variable for the actuator from the function and to actuate the actuator using the determined manipulated variable.

9. The device according to claim 1, wherein the electrical energy source is provided for supplying energy to the electrolysis unit or the reciprocating piston compressor.

10. The device according to claim 9, wherein the energy source includes a regenerative energy generation apparatus which is connected to the electrolysis unit or to the reciprocating piston compressor, wherein the energy generation apparatus comprises a photovoltaic system or a wind turbine.

11. The device according to claim 1, wherein the actuator is a pneumatic, hydraulic or electromagnetic actuator.

12. The device according to claim 1, wherein the at least one automatic intake valve is a ring valve, wherein the annular valve has multiple ring-shaped valve openings and multiple ring-shaped valve elements which can be actuated by the unloader.

13. The according to claim 1, wherein the reciprocating piston compressor is a double-acting reciprocating piston compressor or a multi-stage reciprocating piston compressor.

14. A method for operating a device according to claim 1, wherein hydrogen is produced by the electrolysis unit, wherein the hydrogen produced is fed to the reciprocating piston compressor via the at least one intake valve and is compressed by the reciprocating piston compressor, wherein a target value is predetermined for the outlet pressure or for the differential pressure and that the control unit actuates the actuator in order to set the target value.

15. The method according to claim 14, wherein a fixed numerical value is used as the target value or the target value is determined from a function on the basis of at least one further variable.

16. The method according to claim 14, wherein, during operation of the device, an actual value of the outlet pressure or of the differential pressure is determined and the control unit determines a manipulated variable for the actuator from the actual value and the target value and actuates the actuator using the determined manipulated variable, wherein the manipulated variable is determined by a controller.

17. The method according to claim 14, wherein a manipulated variable for the actuator is determined from a function of the manipulated variable on the basis of the predetermined target value and the control unit controls the actuator using the determined manipulated variable.

18. The method according to claim 14, wherein the electrolysis unit is directly supplied with a temporally non-constant electrical energy by a regenerative energy generation apparatus and the control unit controls the outlet pressure or the differential pressure to a predetermined target value.

19. The method according to claim 14, wherein the electrolysis unit is deactivated or an electrical energy supply to the electrolysis unit is interrupted and the control unit reduces the outlet pressure to a specified value in accordance with a predetermined time function.

20. The method according to claim 14, wherein the reciprocating piston compressor is operated at a fixed constant speed.
